(19) United States
(12) Patent Application Publication
(10) Pub. No.: US 2025/0192532 A1
(43) Pub. Date: Jun. 12, 2025

(54) SWIVELLING CABLE FASTENER AND DYNAMIC CABLE GUIDING METHOD

(71) Applicant: LATELEC, Toulouse (FR)

(72) Inventors: Jay Nicholas, Great Brittain (GB); Eric Bonte, Great Brittain (GB)

(73) Assignee: LATELEC, Toulouse (FR)

(21) Appl. No.: 18/843,274

(22) PCT Filed: Feb. 28, 2023
(86) PCT No.: PCT/EP2023/054936

§ 371 Date: Sep. 2, 2024

(30) Foreign Application Priority Data
Mar. 2, 2022 (FR) FR2201819

(51) Int. Cl. H02G 3/32; F16L 3/015; F16L 3/10

(52) U.S. Cl. CPC H02G 3/32; F16L 3/015; F16L 3/1091

(57) ABSTRACT

A cable fastener for fastening at least one cable to a structure, a portion of which is movable between an initial position and a final position, this cable fastener including a base plate defining a reference plane and secured to the structure, and a cable clamp, this cable clamp being inserted into the base plate, this cable fastener having a return device arranged between the cable clamp and the base plate, and holds the cable clamp in a nominal position when the movable part of the structure is in its initial position. The cable clamp pivots about a pivot axis in the base plate from this nominal position when at least one of the cables is stressed in a direction by the movement of the movable part of the structure and pivots back to the nominal position under the effect of the return device when the cables are released.

### CROSS REFERENCE TO RELATED APPLICATION

This application is a national stage entry of PCT/EP2022/084759 filed Dec. 7, 2022, under the International Convention and claiming priority over French Patent Application No. FR2114144 filed Dec. 21, 2021.

### TECHNICAL FIELD

The invention relates to a cable fastener enabling the useful length of a cable to be dynamically adjusted by pivoting, and to a method of guiding a cable using such a fastener. More generally, the present invention relates to means for attaching and adjusting a cable in a structure, part of which is movable, the cable extending over this movable part and accompanying its movement. The cables covered by the invention are any type of signal- or energy-carrying cable, either individually or in a bundle. In particular, vehicles—aircraft, automobiles, trains, ships—and buildings are intended to be fitted with fasteners.

Such fasteners are used to bring cables into constrained areas of a mobile structure with limited installation space. For example, in the aeronautical world, landing gear door panels are mobile structures which, when open, allow the landing gear to be extended and, when closed, keep the fuselage closed. These panels have cables in their internal structure which must adjust to the open or closed position of the panels.

Particularly in the world of aeronautics, structural optimization is leading to a reduction in the amount of free space available for cable installation. It is therefore particularly appropriate that cable mounting brackets should be multifunctional, allowing adjustment of cable length.

### STATE OF THE ART

In aircraft structures, cable trays are generally used to route cables within the aircraft, particularly in the wings and cabin, with the additional function of protecting and insulating the cables they carry. However, they cannot be used in very narrow spaces such as wingtips, as the space available is too small. Furthermore, cable trays cannot be used to adjust the usable length of the cables they carry.

Other common fasteners, such as P-clips or clamps, do not allow adjustment of cable length after installation: their function is to fix and hold cables in place.

Traditionally, the adjustment of a cable length after installation is carried out using cable chains. Such a device is used in particular as a mechanical part of machines for guiding cables connected to a moving structure. However, such a solution requires the installation of additional guide rails, which frame the cable chains and thus take up a considerable amount of space: such a solution is therefore not suitable for use in narrow spaces.

What's more, the structure on which these cable-carrying chains are installed is designed to support the additional weight of the guide rails, and installing them requires labor and tools. This solution therefore fails to meet the basic requirements of lightweight structures and rapid installation.

### DESCRIPTION OF THE INVENTION

In order to overcome the above-mentioned disadvantages of the state of the art, the main aim of the invention is to enable a cable to be attached and its useful length adjusted within a structure, part of which is mobile, this structure offering a reduced space for fulfilling these objectives.

For this purpose, the invention relates to a cable fastener for attaching a cable to a structure, this fastener having a degree of freedom, particularly in rotation, enabling the length of the cable to adjust in relation to the movable part of the structure to which it is attached. This adjustment of the cable length is sought to avoid hindering the mobility of the structure and damaging the devices connected by the cable.

More precisely, the object of the present invention is a cable fastener for fixing at least one cable to a structure, part of which is movable between an initial position and an end position. This cable fastener comprises a base plate defining a reference plane and integral with the structure, as well as a cable clamp, this cable clamp being inserted into the base plate. The cable fastener also comprises a return means arranged between the cable clamp and the base plate, each of which has an anchoring mechanism in connection with this return means, the latter holding the cable clamp in a nominal position when the movable part of the structure is in its initial position. In addition, the cable clamp pivots along a pivot axis in the base plate from this nominal position when at least one of the cables is loaded in one direction by the movement of the moving part of the structure, and pivots back to the nominal position under the effect of the return means when the cables are released.

Advantageously, the cable fasteners according to the invention can be adapted to mobile structures and allow the installation of devices and mechanisms requiring wiring, such as locking or illumination systems, the useful length of these cables adapting to the movement of the mobile structure.

Advantageously too, the cable fastener has compact dimensions and operates independently of any additional installations such as guide rails or power sources. These compact dimensions enable the attachment to be installed in spaces where space is at a premium.

Advantageously too, the cable fastener operates purely mechanically, with dynamic return of the cables under the action of the return means, eliminating the need for additional power cables and actuating means, and reducing the weight of cable installation systems.

Advantageously too, the anchoring mechanisms for the return means are integrated into the cable clamp and base plate, simplifying installation of the fastener.

Advantageously too, the cable clamp is only rotatable, so its overall dimensions hardly change as the structure moves.

According to some preferred embodiments taken alone or in combination:
the base plate is fixed to the structure by at least two screws;
the cable clamp is clipped onto the base plate;
the cable clamp and the base plate are made of molded plastic;
the cable clamp comprises a cable support closed by a cover;
the cover is snap-fitted onto the cable support;
the cable support comprises a base plate perpendicular to the pivot axis and a cylindrical rod extending along this axis beneath the base plate, this cylindrical rod having an end which fits into the base plate;
the end of the cylindrical rod has at least two flexible teeth which pass through the base plate and bear on an underside of the base plate;
the return means is a torsion spring about an axis coincident with the pivot axis of the clamp and has a body and two ends extending tangentially to this body;
the base plate has a hollow cylinder around which the torsion spring is arranged and into which the cable support of the clamp is inserted;
each anchoring mechanism comprises at least one stop, perpendicular to the reference plane, against which a lateral portion of one end of the torsion spring bears;
the cable clamp anchoring mechanism is integrated into the base plate, and
the base plate anchoring mechanism comprises two parallel stops for preventing rotation of the end of the torsion spring in connection with the base plate.

Advantageously, installation of such a cable fastener is quick and easy, without the need for special tools. The use of plastic materials also makes it possible to provide electrical insulation, particularly when the cables are electrical.

The invention also relates to a method for dynamically adjusting a cable length in a structure, part of which is movable back and forth between an initial position and a final position, this structure being equipped with at least one cable fastener, which is also the subject of the invention. A preliminary installation phase involves the following steps:
determination of the maximum cable length required;
dimensioning of the return means according to the cable characteristics;
orientation of the base plate on the structure in order to orient the cable clamp in the direction of cable loading when the moving part of the structure is in its final position.

Forward adjustment takes place in the following stages:
in the initial position of the movable part, the return means holds the cable clamp in its nominal position, in which the cable is bent and untensioned, creating a cable reserve that can be pulled out;
movement of the moving part of the structure between its initial position and its final position, exerting an unwinding tension on the cable;
rotation of the cable clamp from its nominal position, which guides the unwinding of the previously bent cable;
the moving part reaches its final position, and the return means exerts a tension on the cable which is the opposite of the unwinding tension, by driving the clamp in reverse rotation.

And the backward adjustment takes place in the following stages:
movement of the moving part of the structure between its final position and its initial position, accompanied by release of the tension in the cable;
reverse rotation of the cable clamp until the nominal position is reached, by action of the return means and traction of the cable.

Advantageously, the installation process optimizes the length of cable installed in the structure, saving weight and space within the structure. The return means makes it possible to order the cables when their full length is not required by the structure, particularly in the initial position.

Advantageously, this dynamic adjustment also makes it possible to secure cable management and the operation of connected equipment when the moving part of the structure moves back and forth several times between the initial position and the final position.

According to a preferred form of implementation:
at least two fasteners installed in parallel adjust at least two cables in the structure.

### DESCRIPTION OF THE FIGURES

Further features and advantages of the present invention will become apparent from the following detailed embodiment, without limiting the scope thereof, with reference to the appended figures, which show, respectively:

FIG. 1, a perspective view of a cable held by a fastener to a structure;

FIG. 2, an exploded perspective view of the fastener;

FIG. 3, a cross-sectional view of the fastener, and

FIG. 4 shows a view of the system on a stage of the adjustment process;

FIG. 5 shows a view of the system on another stage of the adjustment process; and

FIG. 6 shows a view of the system at another stage of the adjustment process.

### DETAILED DESCRIPTION

In the figures, identical reference signs refer to the same element and to the corresponding passages in the description.

In aeronautical structures, and in particular in aircraft, at least one part of said structure is mobile between an initial position and an end position, such as landing gear doors or wingtips. These rotationally or translationally mobile parts are wired in the same way as the rest of the aircraft structure, the installation of these cables having to be adapted to this mobility to enable the structure to function properly and not hinder this mobility.

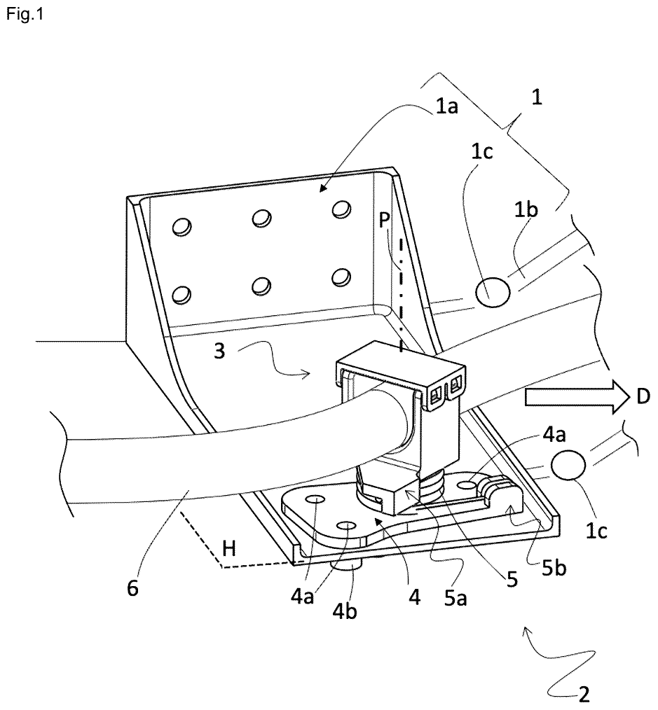

For this purpose, FIG. 1 shows a cable 6 held in a cable fastener 2 integral with an aircraft wingtip structure 1. One part of the structure 1, a support 1a, is fixed in a given frame of reference, and another part 1b is mobile in this frame of reference. The support 1a and mobile 1b part of structure 1 are connected by articulation means 1c, shown schematically, for example hinges.

This cable fastener 2 comprises a base plate 4 defining a reference plane H. This base plate 4 has three holes 4a, each of which accommodates a screw 4b securing the base plate 4 to the support 1a of the structure 1. Alternatively, the base plate 4 can be clipped, glued, welded or riveted to the support 1a. The cable fastener 2 also comprises a cable clamp 3 inserted in the base plate 4 and a return means, in this case a torsion spring 5. The torsion spring 5 is arranged between the cable clamp 3 and the base plate 4, each of which has an anchoring mechanism 5a, 5b in connection with the torsion spring 5, which holds the cable clamp 3 in a nominal position when the movable part of the structure 1 is in its initial position.

In the final position, the mobile part 1b is in an intermediate position between the initial position and an alignment position in the extension of the fixed part in the reference plane H.

In addition, the cable clamp 3 pivots in the base plate 4 along a pivot axis P, perpendicular to the reference plane H, from said nominal position when the cable 6, also integral with this movable part, is loaded in direction D by the movement of the movable part of the structure 1. During this rotation, the torsion spring 5 accumulates energy by deformation. The cable clamp 3 returns to its nominal position by the return of the torsion spring 5 when the cable 6 is released—by mechanical release of the energy accumulated by deformation—in particular when the moving part of the structure 1 returns to its initial position. Alternatively, and depending on the configuration of the structure 1, the pivoting axis P may, in particular embodiments, not be perpendicular to the reference plane H.

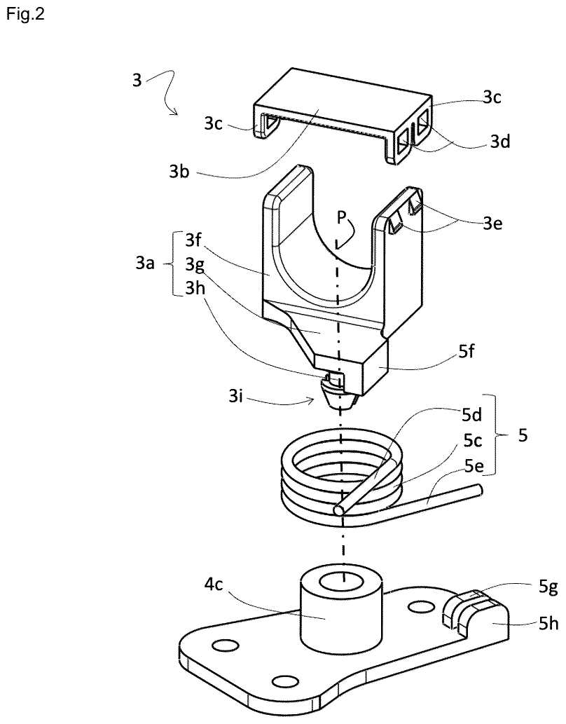

The components of the cable fastener 2 are illustrated in the exploded perspective view of FIG. 2: the cable clamp 3 comprises a cable support 3a closed by a cover 3b, here clipped laterally on either side of the cable support 3a. To this end, the cover 3b has two lateral flanges 3c, each pierced by two apertures 3d which clip onto lugs 3e arranged on either side of the cable support 3a. The cover 3b is here assembled by two clips on each lateral flange 3c to improve security and remain held in the event of breakage of one of the tenon 3e-opening 3d junctions: in other embodiment examples, the cover 3b may simply be clipped and/or comprise a locking means. Alternatively, cover 3b can be connected by a cord to one side of cable support 3a and clipped to the other side, cable support 3a and cover 3b then forming a single part. In other embodiments, the cable clamp can be assembled using fasteners and/or flanges. A set of grooves and ribs arranged on the cover and cable support and then locked can also be used to assemble the cable clamp.

The cable support 3a has three superimposed functional members: a “U”-shaped block 3f, a base plate 3g perpendicular to the pivot axis P, and a cylindrical rod 3h which extends along this pivot axis P under the base plate 3g. This cylindrical rod 3h has an end 3i which inserts into the base plate 3g. In addition, the block 3f supports the cable 6 and has the pins 3e at its ends.

In the example shown, the base plate 4 comprises a hollow cylinder 4c, around which the torsion spring 5 is arranged and into which the cable support 3a of the clamp 3 is inserted via the cylindrical rod 3h. The connection between the hollow cylinder 4c and the cylindrical rod 3h enables the cable clamp 3 to pivot in the base plate 4 along the pivot axis P perpendicular to the reference plane H.

In this case, the return means is a torsion spring 5 whose axis coincides with the pivot axis P of the cable clamp 3. This torsion spring 5 has a body 5c and two ends 5d, 5e extending tangentially to this body 5c. The ends 5d, 5e remain connected to the anchoring means 5a, 5b of the clamp 3 and the base plate 4 respectively.

In addition, each anchoring means 5a, 5b comprises at least one stop—5f for anchoring means 5a and 5g, 5h for anchoring means 5b—perpendicular to the reference plane H, and against which a lateral portion 5i, 5j of one end 5d, 5e of the torsion spring 5 bears.

In addition, the anchoring means 5a of the clamp is integrated into the base plate 3g, with the stop 5f forming a right angle with the base plate 3g.

In addition, the anchoring means 5b on the base plate 4 comprises two parallel stops 5g, 5h for preventing rotation of the end 5e of the torsion spring 5 in connection with the base plate 4. As this end 5e is locked against rotation about the pivot axis P, only the end 5d is rotatable when the torsion spring 5 is twisted: thus, pulling the cable 6 causes the clamp 3 to pivot about the axis P to align the direction of the cable 6 with the pulling direction. During this rotation, the stop 5f of the anchoring means 5a rotates the end 5d of the torsion spring 5. When cable tension 6 is released, torsion spring 5 is free to exert a restoring force on stop 5f, resulting in the formation of a return rotation pivot of clamp 3.

Preferably, cable clamp 3 and base plate 4 are made of molded plastic material, which provides electrical insulation. Alternatively, when electrical insulation is not required, cable clamp 3 and base plate 4 can be molded and/or machined from a metallic material, or made from composite materials.

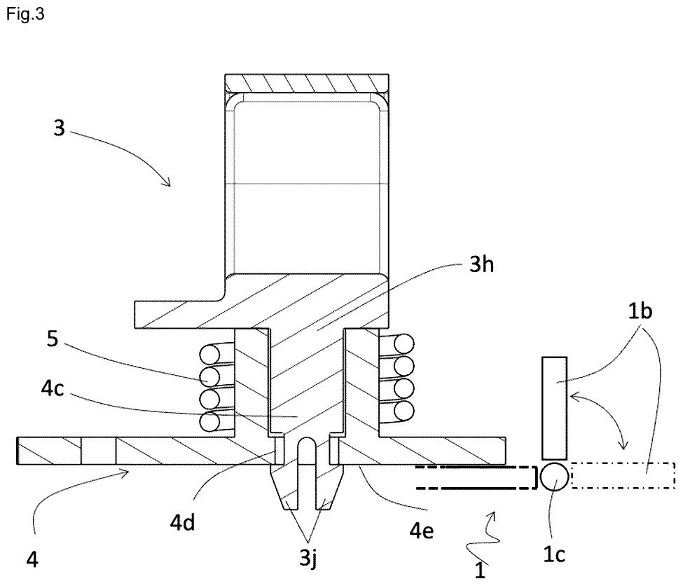

The sectional view shown in FIG. 3 details the connections between the cable clamp 3 and the base plate 4. The cylindrical shaft 3h of the cable clamp 3 pivots in the hollow cylinder 4c. In addition, the base plate 4 has an opening 4d, continuous with the hollow cylinder 4c, through which the end 3i of the clamp is inserted. This end 3i has two flexible teeth 3j which pass through the base plate 4 via the opening 4d and rest on the underside 4e of the base plate 4. These flexible teeth 3j enable the cable clamp 3 to be clipped onto the base plate 4.

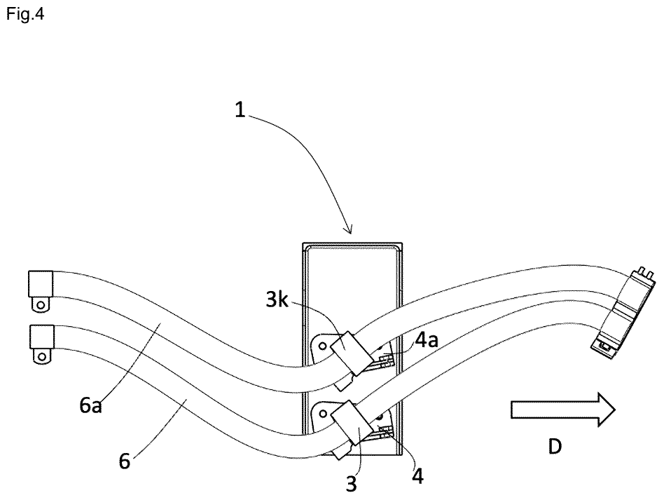

FIGS. 4, 5 and 6 illustrate the various stages of an example of a process for dynamically adjusting a cable length in structure 1, a movable part of which moves back and forth—between an initial position and a final position—this structure 1 being equipped with two cable fasteners. In this example, two cables 6 and 6a are each attached to structure 1 by a cable fastener 2 and 2a installed in parallel. Alternatively, a single fastener can be used for two cables.

A preliminary step for installing cables 6 and 6a involves the following steps:
determining, for each cable, the maximum cable length enabling the moving part of the structure to perform its movements;
dimensioning the torsion spring according to the mechanical characteristics of the cable;
orienting the base plate 4, 4a on the structure 1 in order to orient the cable clamp 3, 3k in the direction of stress D of the cable 6 when the moving part of the structure is in its final position.

Once the cables have been installed, they are bent and slackened to create a cable reserve in the vicinity of the clamp, which can be unfolded in a controlled manner by the clamp when the cables are under tension. The return means, in this case the torsion spring, allows the fastener to pivot in order to replenish this reserve when the cables are no longer under tension.

The adjustment process is carried out in the following steps:—

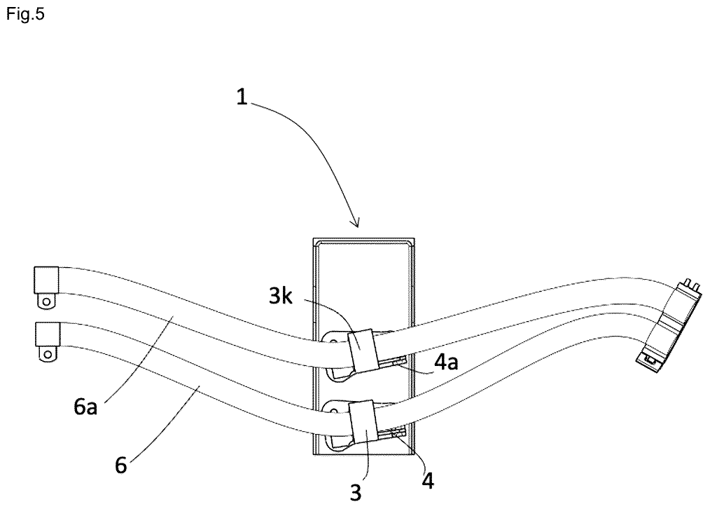

in the initial position of the moving part shown in FIG. 4, the torsion spring 5 holds the cable clamp 3, 3k in its nominal position, in which the cable 6, 6a is bent and unbent, providing a reserve of cable that can be used;
moving the moving part of the structure between its initial position and its final position, exerting an uncoiling tension on the cable 6, 6a;
rotating the cable clamp 3, 3k from its nominal position, which guides the uncoiling of the previously bent cable 6, 6a;
the moving part reaches its final position, which guides the uncoiling of the previously bent cable 6, 6a;
rotation of the cable clamp 3, 3k from its nominal position, which guides the unwinding of the previously bent cable 6, 6a;
the moving part reaches its final position in FIG. 5, and the torsion spring 5 exerts a tension opposite to the unwinding tension on the cable 6, 6a, by driving the cable clamp 3, 3k in opposite rotation.

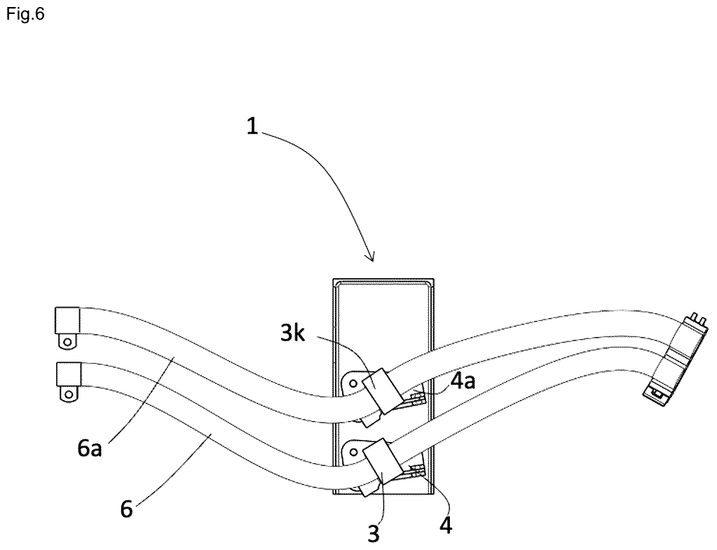

And the backward adjustment process takes place in the following steps:
movement of the movable part of the structure between its final position (FIG. 6) and its initial position (FIG. 4) accompanied by release of the tension in the cable 6, 6a;
reverse rotation of the cable clamp 3, 3k until the nominal position is reached by action of the torsion spring 5 and pulling of the cable 6, 6a.

The invention is not limited to the examples described and shown. For example, the base plate of the clamp can be an integral part of the structure, in which case the clamp is attached and pivots directly on the structure. The return means can also be provided by any type of spring (leaf, tension, compression) or by more complex mechanisms with cylinders: the hollow cylinder of the base plate is then no longer necessary, as the clamp can pivot directly with respect to the base plate.

Alternatively, the anchoring mechanism can be achieved by any retention of the spring ends using fastening rings, locks or perforation of the base plate and base plate into which the spring ends are folded.

1. A cable fastener (2) for fastening at least one cable (6) to a structure (1), part of which is movable between an initial position and an end position, the cable fastener (2) comprising:
a base plate (4) defining a reference plane (H) and integral with the structure (1);
a cable clamp (3), the clamp (2) being inserted in the base plate (4);
a return device arranged between the cable clamp (3) and the base plate (4), each of which has an anchoring mechanism (5a, 5b) connected to the return device, the latter holding the cable clamp (3) in a nominal position when the movable part of the structure (1) is in the initial position;
the cable clamp (3) pivoting about a pivot axis (P) in the base plate from the nominal position when at least one of the cables is stressed in a direction (D) by the movement of the movable part of the structure (1) and pivoting back to the nominal position under the effect of the return device when the cables are released, and the return device being a torsion spring (5) along an axis coincident with the pivot axis (P) of the cable clamp (3) and comprises a body (5c) as well as two ends (5d, 5e) extending tangentially with respect to the body (5c),
wherein the base plate (4) has a hollow cylinder (4c) around which the torsion spring (5) is arranged and into which the cable support (3a) of the cable clamp (3) is inserted.

2. The cable fastener (2) according to claim 1, wherein the base plate (4) is secured to the structure (1) by at least two screws (4b).

3. The cable fastener (2) according to claim 1, wherein the cable clamp (3) is clipped onto the base plate (4).

4. The cable fastener (2) according to claim 1, wherein the cable clamp (3) and the base plate (4) are made of molded plastic material.

5. The cable fastener (2) according to claim 1, wherein the cable clamp comprises a cable support (3a) closed by a cover (3b).

6. The cable fastener (2) according to claim 5, wherein the cover (3b) is clipped onto the cable support (3a).

7. The cable fastener (2) according to claim 5, wherein the cable support (3a) comprises a base plate (3g) perpendicular to the pivot axis (P) and a cylindrical rod (3h) extending along the axis beneath the base plate (3g), the cylindrical rod (3h) having an end which inserts into the base plate (4).

8. The cable fastener (2) according to claim 1, wherein each anchoring mechanism (5a, 5b) comprises at least one stop (5f, 5g, 5h), perpendicular to the reference plane (H), against which a lateral portion (5i, 5j) of one end (5d, 5e) of the torsion spring (5) comes to bear.

9. The cable fastener (2) according to claim 7, wherein the anchoring mechanism (5a) of the cable clamp (3) is integrated into the base plate (3g).

10. The cable fastener (2) according to claim 8, wherein the anchoring mechanism (5b) of the base plate (4) comprises two parallel stops (5g, 5h) for preventing rotation of the end (5e) of the torsion spring (5) in connection with the base plate (4).

11. A method of dynamically adjusting a cable length in a structure (1), part of which is movable back and forth between an initial position and a final position, the structure (1) being equipped with at least one cable fastener (2) according to claim 1, wherein a preliminary installation phase takes place according to the following steps:
determining the maximum length of cable (6) required;
dimensioning of the return device as a function of the characteristics of the cable (6);
orientation of the base plate device (4) on the structure (1) in order to orient the clamp the cable clamp (3) in the direction of stress (D) of the cable (6) when the movable part of the structure is in the final position;
in that the forward adjustment takes place according to the following steps:
in the initial position of the movable part, the return device holds the cable clamp (3) in the nominal position in which the cable (6) is bent and slackened, providing a cable reserve that can be pulled;
moving the movable part of the structure between the initial position and the final position by exerting an unwinding tension on the cable rotation of the cable clamp (3) from the nominal position, which guides the unwinding of the previously bent cable (6);
the movable part reaches the final position and the return device exerts a traction inverse to the unwinding tension on the cable (6) by driving the clamp in opposite rotation; and
the backward adjustment takes place according to the following steps:
movement of the movable part of structure 1 between the final position and the initial position, accompanied by release of the tension in the cable;
reverse rotation of the cable clamp (3) until the nominal position is reached, by action of the return device and pulling of the cable (6).

12. A method of dynamically adjusting a cable length according to claim 11, wherein at least two cable fasteners (2, 2a) installed in parallel adjust at least two cables (6, 6a) in the structure 1.
